(19) United States
(12) Patent Application Publication
(10) Pub. No.: US 2014/0082599 A1
(43) Pub. Date: Mar. 20, 2014

(54) METHOD AND APPARATUS FOR UPDATING ELECTRONIC CONTROL UNIT IN SYSTEM BASED ON AUTOMOTIVE OPEN SYSTEM ARCHITECTURE

(71) Applicant: Electronics & Telecommunications Research Institute, (US)

(72) Inventor: Jong Uk KIM, Daejeon (KR)

(73) Assignee: Electronics & Telecommunications Research Institute, Daejeon (KR)

(21) Appl. No.: 13/799,665

(22) Filed: Mar. 13, 2013

(30) Foreign Application Priority Data
Sep. 20, 2012 (KR) 10-2012-0104547

(51) Int. Cl. G06F 9/445

(52) U.S. Cl. CPC G06F 8/65
USPC 717/168

(57) ABSTRACT

Disclosed are an ECU update method and apparatus of an AUTOSAR-based system. In the ECU update method, an MCAL driver layer receives ECU update data, and an ECAL driver layer receives the ECU update data from the MCAL driver layer and directly transfers the ECU update data to ECU update software. Therefore, the ECU update method minimizes unnecessary operations in updating an ECU while performing an operation conforming to the AUTOSAR standard, thus quickly updating the ECU.

### CLAIM FOR PRIORITY

This application claims priority to Korean Patent Application No. 10-2012-0104547 filed on Sep. 20, 2012 in the Korean Intellectual Property Office (KIPO), the entire contents of which are hereby incorporated by reference.

### BACKGROUND

1. Technical Field

Example embodiments of the present invention relate in general to a method and apparatus for updating an electronic control unit (ECU) for vehicles, and more particularly, to a method and apparatus that update an ECU of a vehicle in an automotive open system architecture (AUTOSAR) software system that is the vehicle electronics field software standard.

2. Related Art

AUTOSAR is a conference group for vehicle embedded software in which vehicle manufacturers and suppliers of Europe, USA, Japan, etc., having a fundamental concept in which an application and an ECU are separately developed for responding to the complication of an automotive electronic system and a virtual functional bus supports communication between components, massively participate. Also, AUTOSAR denotes a standard name of a software platform for vehicles. When an AUTOSAR platform is applied to a microcontroller unit (MCU) for vehicles, hardware and software are separated, and the reusability and expandability of software are enhanced, thereby enabling quick and reliable development of complicated software.

In methods of updating an ECU for vehicles, a method that updates the ECU through FlexRay communication without detaching the ECU or an ECU module is increasingly used at present. That is, an ECU update method using communication such as FlexRay communication is increasingly used for shortening the working time taken in updating an ECU and increasing efficiency. However, the existing AUTOSAR platform structure does not propose a separate driver structure for update, and the standard requires only a necessary driver structure in execution.

However, when developing an application conforming to the AUTOSAR standard and updating an ECU, the unnecessary movement of a function and the execution of many codes to are needed. For this reason, a method is required for quickly updating an ECU without unnecessarily moving a function or operating an operating system (OS).

### SUMMARY

Accordingly, example embodiments of the present invention are provided to substantially obviate one or more problems due to limitations and disadvantages of the related art.

Example embodiments of the present invention provide an ECU update method that minimizes the unnecessary call of a function and the number of operations of an OS, and thus shortens the time taken in updating an ECU when a system using the AUTOSAR standard structure receives data for ECU update through FlexRay communication and updates the ECU.

Example embodiments of the present invention also provide an ECU update apparatus that minimizes the unnecessary call of a function and the number of operations of an OS, and thus shortens the time taken in updating an ECU when a system using the AUTOSAR standard structure receives data for ECU update through FlexRay communication and updates the ECU.

In some example embodiments, an ECU update method of an AUTOSAR-based system includes: (a) receiving, by an MCAL driver layer, ECU update data; (b) receiving, by an ECAL driver layer, the ECU update data from the MCAL driver layer; and (c) directly transferring, by the ECAL driver layer, the ECU update data to ECU update software.

The ECU update method may further include: stopping an operation of an operating system for ECU update; and deactivating all interrupts other than an interrupt used in elements of a driver layer that receives the ECU update data and transfers the ECU update data to the ECU update software.

The ECU update method may further include: stopping an operation of an operating to system for ECU update, and deactivating all interrupts.

A driver layer, which receives the ECU update data and transfers the ECU update data to the ECU update software, may operate in a polling scheme.

In the MCAL driver layer, a FlexRay communication driver may receive the ECU update data. In the ECAL driver layer, a FlexRay communication interface driver may receive the ECU update driver and directly transfer the ECU update driver to the ECU update software.

The transferring (c) may include directly transferring the ECU update data to the ECU update software without passing through at least one of a protocol data unit router layer, communication module layer, and run time environment layer of the AUTOSAR-based system.

In other example embodiments, an ECU update method of an AUTOSAR-based system includes: stopping an operation of an operating system for ECU update; and deactivating all interrupts other than an interrupt used in elements of a driver layer that receives the ECU update data and transfers the ECU update data to the ECU update software.

The ECU update method may further include stopping the operation of the operating system for ECU update, and deactivating all interrupts that include interrupts used in the elements of the driver layer. Here, the driver layer, which receives the ECU update data and transfers the ECU update data to the ECU update software, may operate in a polling scheme.

In still other example embodiments, an update apparatus for updating an ECU in an AUTOSAR-based system includes: a communication unit configured to receive ECU update data for updating the ECU; a memory unit configured to store a program code for updating the ECU with the ECU update data received from the communication unit; and a control unit configured to execute the program code to control the communication unit, and update the ECU with the ECU update data received from the communication unit.

The communication unit may receive the ECU update data through FlexRay to communication.

The control unit may control the communication unit to directly receive the ECU update data without passing through at least one of a protocol data unit router layer, communication module layer, and run time environment layer of the AUTOSAR-based system, and updates the ECU.

The control unit may stop an operation of an operating system for ECU update, and deactivate all interrupts other than an interrupt that is used for the communication unit to receive the ECU update data and transfer the ECU update data to the control unit. Alternatively, the control unit may stop an operation of an operating system for ECU update, deactivate all interrupts, and control the communication unit in a polling scheme such that the communication unit receives the ECU update data and transfers the ECU update data to the control unit.

### BRIEF DESCRIPTION OF DRAWINGS

Example embodiments of the present invention will become more apparent by describing in detail example embodiments of the present invention with reference to the accompanying drawings, in which:

FIG. 1 is a block diagram for describing a layered software architecture of the AUTOSAR;

FIG. 2 is a block diagram for describing an interface between components when an AUTOSAR-based system updates an ECU through FlexRay communication;

FIG. 3 is a block diagram for describing an interface between components when the AUTOSAR-based system updates an ECU through FlexRay communication, according to the present invention;

FIG. 4 is a flowchart for describing a method of updating an ECU through FlexRay communication in the AUTOSAR-based system, according to the present invention; and

FIG. 5 is a block diagram for describing an apparatus for updating an ECU through FlexRay communication in the AUTOSAR-based system, according to the present invention.

### DESCRIPTION OF EXAMPLE EMBODIMENTS

The invention may have diverse modified embodiments, and thus, example embodiments are illustrated in the drawings and are described in the detailed description of the invention.

However, this does not limit the invention within specific embodiments and it should be understood that the invention covers all the modifications, equivalents, and replacements within the idea and technical scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

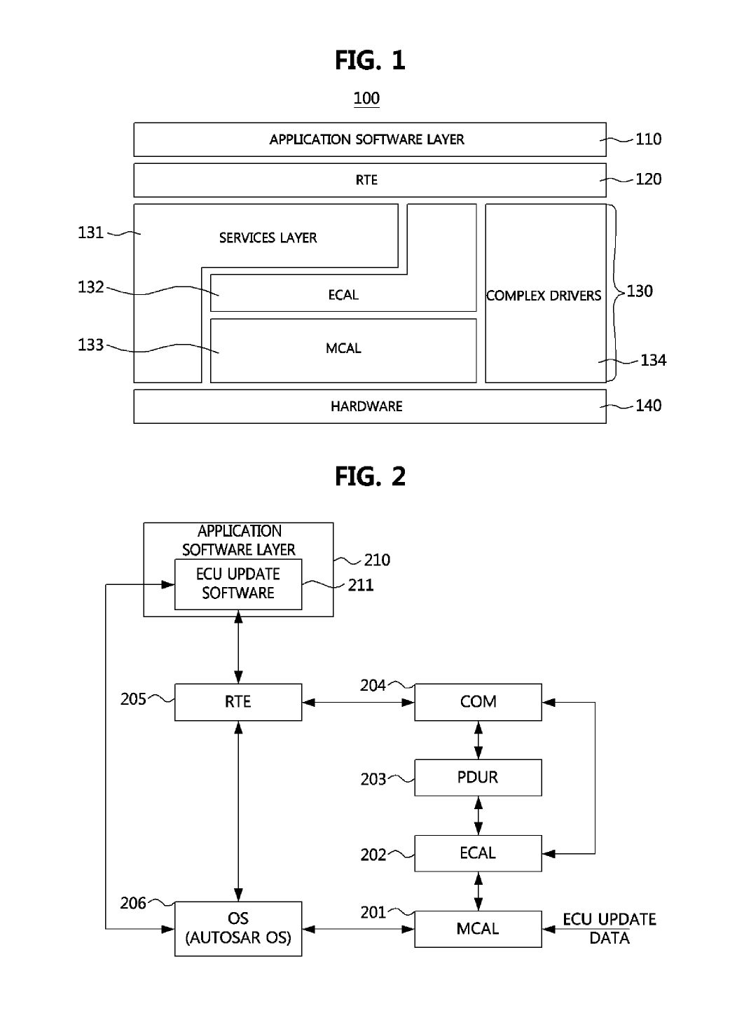

FIG. 1 is a block diagram for describing a layered software architecture of the AUTOSAR.

Referring to FIG. 1, a layered software architecture of the AUTOSAR is disclosed. A layered software architecture 100 of the AUTOSAR has a layered structure in which the layered software architecture 100 is largely divided into an application software layer 110, a run time environment (RTE) 120, and a basic software (BSW) layer 130.

Especially, the BSW layer 130 is subdivided into a services layer 131, an ECU abstraction layer (ECAL) 132, and a microcontroller abstraction layer (MCAL) 133.

In the layered software architecture 100, the ECAL 132 and the MCAL 133 are layers that are changed dependently on the hardware 140, and are changed to suitable software each time the hardware 140 is changed. That is, the ECAL 132 is changed depending on an ECU circuit, and the MCAL 133 is changed depending on a used MCU. Therefore, the MCAL 133 is mainly developed in the form of device driver software of an MCU by a semiconductor manufacturer. The MCAL 133 directly accesses hardware, and thus performs an important operation in relation to timing, etc. When the application software layer 110 needs to directly access hardware, the ECAL 132, the MCAL 133, and a complex driver 134 are used.

The layered software architecture will now be described in more detail.

First, the implementation of the application software layer 110 is not treated by the AUTOSAR, and the application software layer 110 is implemented independently from a hardware layer such as a microcontroller and communicates with all resources of a lower layer and the RTE layer 120. For example, a plurality of application software included in the application software layer 110 overall receive various signals from a plurality of hardware of a lower layer, process the signals, and overall control the plurality of hardware of the lower layer. Such application software is developed by developers, for achieving a specific object. That is, the implementation of the application software layer 110 in the layered software structure may not be affected by the detailed change in the lower layer.

Next, the RTE layer 120 provides a hardware independent layer for the BSW layer 130 of a lower layer to the application software layer 110. Also, software components included in the application software layer 110 communicate with each other through the RTE layer 120. That is, the RTE layer 120 acts as a communication center that manages data exchange between components of the application software layer 110, and data exchange between the components of the application software layer 110 and the BSW layer 130.

The BSW layer 130 provides the services layer 131, which abstracts ECU hardware and a microcontroller and provides a basic service, to the application software layer 110. For example, services provided by the services layer 131 includes OS services, vehicle network communication and management services, memory services, diagnosis services, and ECU state management services. Therefore, the services layer 131 is partially dependent on hardware such as the microcontroller and the ECU, but provides a hardware independent interface to an upper layer. Also, the BSW layer 130 includes the ECAL 132 for abstracting the ECU for the upper layer. The ECAL 132 includes a plurality of handlers that are a plurality of software for abstracting peripheral devices connected to a central processing unit (CPU).

Finally, the MCAL 133 of the BSW layer 130 is a layer that is directly changed dependently on a hardware 140, and processes direct access to peripheral devices included in the hardware 140, internal devices, external devices, and a memory. That is, the MCAL 133 prevents an upper layer from directly manipulating a register of the microcontroller. Accordingly, the MCAL 133 of the BSW layer 130 is newly developed into suitable software each time hardware is changed (for example, whenever hardware mounted on a new vehicle and a vehicle is changed).

As described above, the AUTOSAR standard strictly defines application software and an RTE with the layered software architecture, and thus maintains the reusability and expandability of software and enables the quick and reliable development of software.

As described above in the background, in methods of updating an ECU for vehicles, a method that updates the ECU through communication such as FlexRay communication without detaching the ECU or an ECU module is increasingly used at present.

That is, an ECU update method using communication such as FlexRay communication is increasingly used for shortening the working time taken in updating an ECU and increasing efficiency. However, the existing AUTOSAR platform structure does not propose a separate driver structure for update, and the standard defines only a necessary driver structure in execution. In this case, two FlexRay communication drivers or two or more drivers having the same type are used for updating an ECU in terms of development.

The following description will be made on limitations of a case in which the AUTOSAR-based system updates an ECU through FlexRay communication.

FIG. 2 is a block diagram for describing an interface between components when an AUTOSAR-based system updates an ECU through FlexRay communication.

Referring to FIG. 2, an ECU update method in a system based on the AUTOSAR standard structure performs many operations.

That is, when an ECU update software 211 for actually updating an ECU is assumed as being included in an application software layer 210, ECU update data received through a FlexRay communication module is transferred to the ECU update software 211 through several layers.

For example, ECU update data received by a FlexRay driver (FRDRV) of an MCAL 201 is transferred to a protocol data unit router (PDUR) layer via a FlexRay interface driver (FRIF) of the ECAL 202 (for example, the name and kind of driver configuring each layer may be variously defined).

The PDUR layer 203 transfers received data to a communication module (COM) layer 204, which transfers the data to the ECU update software 211 of the application software layer 210 via an RTE layer 205.

As described above with reference to FIG. 1, the reason that data is transferred via several layers is because a layered/abstracted software architecture is applied for maintaining the reusability and expandability of software in the AUTOSAR standard structure, and supporting the quick and reliable development of software.

However, it is really impossible for a system to perform operations, having an object other than an object for performing ECU update, when updating the ECU. For this reason, considering only ECU update, most procedures are unnecessary.

In the other limitations of a case that updates an ECU through FlexRay communication, the existing system frequently performs an interrupt operation, an unnecessary task operation, and an interrupt service routine (ISR) operation for an OS 206 actually irrelevant to ECU update when updating the ECU.

This denotes that most codes are unnecessary codes in updating the ECU, and ECU update becomes slower for executing the codes and a function. Also, this denotes that a developer needs to develop a separate application program and consider processing on stop, restart, and various interrupts of an OS, for performing update faster than update using a DCM module.

ECU Update Method According to the Present Invention

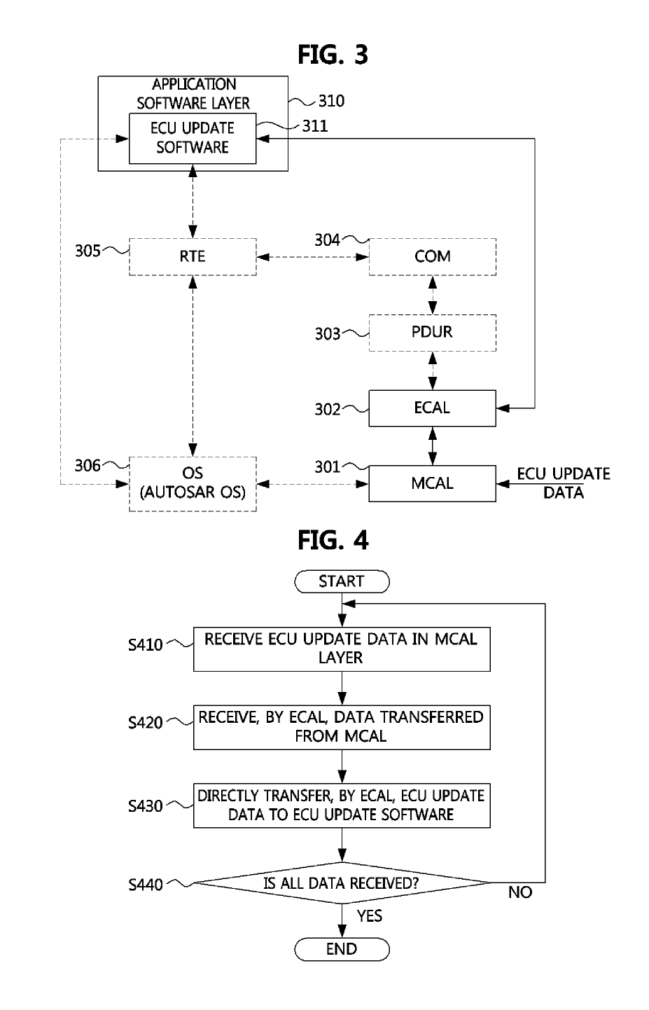

FIG. 3 is a block diagram for describing an interface between components when the AUTOSAR-based system updates an ECU through FlexRay communication, according to the present invention.

Referring to FIG. 3, in an ECU update method according to the present invention, ECU update data inputted to a driver (for example, a FlexRay driver (FRDRV)) of an MCAL 301 is directly transferred to an ECU update software 311 of an application software layer 310 via a driver (for example, a controller area network (CAN) interface driver (FRIF)) of an ECAL 302.

Comparing with the structure of FIG. 2, the ECU update method according to the present invention transfers ECU update data from the MCAL 301 to the ECU update software 311 via only the ECAL 302, unlike a structure in which ECU update data is transferred to an application software layer 310 through the MCAL 301, the ECAL 302, a PDUR 303, a COM layer 304, and an RTE layer 305. Accordingly, the ECU update method according to the present invention reduces the number of unnecessary jumps.

A method applicable to ECU update using FlexRay communication will be described as a configuration additional to the above-described direct transfer configuration of ECU update data.

In the additional configuration of the ECU update method according to the present invention, an interrupt irrelevant to ECU update occurs continuously in an OS 306, and thus, an operation is largely divided into two modes so as to decrease problems affecting ECU update speed.

A first mode is a mode that maintains the operating state of the OS 306 as-is and reduces only the number of unnecessary jumps, namely, a mode that maintains the existing operation of the OS 306 as-is and updates an ECU.

A second mode updates an ECU after stopping the operation of the OS 306, and then again starts the operation of the OS 306.

In this case, the operation of the OS 306 may stop, and all services other than an interrupt service necessary for ECU update may stop. Alternatively, all interrupt services may stop, and ECU update may be performed by only a polling scheme.

FIG. 4 is a flowchart for describing an example of a method of updating an ECU through FlexRay communication in the AUTOSAR-based system, according to the present invention.

Referring to FIG. 4, the ECU update method according to the present invention is an ECU update method of the AUTOSAR-based system, and may include operation 5410 in which an MCAL driver layer receives ECU update data, operation 5420 in which an ECAL driver layer receives the ECU update data from the MCAL driver layer, and operation 5430 in which the ECAL driver layer transfers the ECU update data to ECU update software. The ECU update data is received from the MCAL driver layer in the form of several data units (packet or frame), and thus, operations 5410 to 5430 are repeatedly performed until all ECU update data is received (operation 5440) in updating an ECU.

In this case, in the MCAL driver layer, a FlexRay communication driver (FRDRV) may receive the ECU update data. Thus, in the ECAL driver layer, a driver that receives the ECU update data and directly transfers the ECU update data to the ECU update software, may be a FlexRay communication interface driver (FRIF).

In the above-described update method according to the present invention, as described above with reference to FIG. 3, ECU update data is directly transferred from the driver layers to the ECU update software without passing through the PDUR, COM, and RTE layers of the AUTOSAR system. However, in FIG. 3, it is described above that ECU update is transferred to the ECU update software without passing through the PDUR, COM, and RTE layers, but the ECU update data may not pass through at least one of the PDUR, COM, and RTE layers according to an implementation example.

Also, another example of the update method according to the present invention may deactivate at least one portion of an interrupt occurring in an OS, for preventing unnecessary time delay in an ECU update operation.

For example, the update method according to the present invention may stop the operation of the OS for ECU update, and deactivate all interrupts other than an interrupt which is used in elements of a driver layer that receives the ECU update data and transfers the ECU update data to the ECU update software.

As another example, the update method according to the present invention may stop the operation of the OS for ECU update, and deactivate all interrupts. In this case, the drivers of the MCAL or ECAL may operate in the polling scheme in order to receive the ECU update data and transfer the ECU update data to the ECU update software.

The above-described other example of the update method according to the present invention may be applied to ECU update using CAN communication, and ECU update using FlexRay communication.

Configuration of ECU Update Apparatus According to the Present Invention

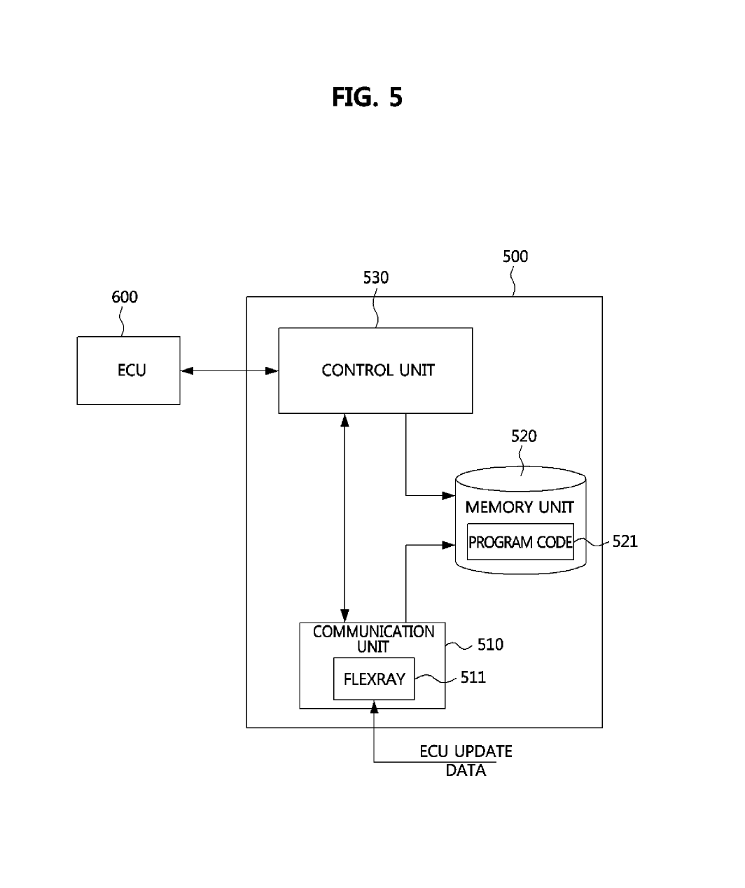

FIG. 5 is a block diagram for describing an apparatus for updating an ECU through FlexRay communication in the AUTOSAR-based system, according to the present invention.

Referring to FIG. 5, an ECU update apparatus 500 according to the present invention is an update apparatus for updating an ECU 600 in the AUTOSAR-based system, and includes: a communication unit 510 that receives ECU update data for updating the ECU 600; a memory unit 520 that stores a program code for updating the ECU 600 with the ECU update data received from the communication unit 510; and a control unit 530 that executes the program code to control the communication unit 510, and updates the ECU 600 with the ECU update data received from the communication unit 510.

The communication unit 510 receives the ECU update data from the outside through FlexRay communication 511, and is controlled by the above-described drivers of the MCAL and ECAL. The communication unit 510 may be controlled by the control unit 530 through the drivers of the MCAL and ECAL.

The memory unit 520 stores executable codes 521 of ECU update software for performing update on the ECU 600, and may store the ECU update data received from the communication unit 510. The memory unit 520 may be configured by combining a non-volatile memory such as a flash memory and a volatile memory such as a random access memory (RAM). The non-volatile memory of the memory unit 520 may store the program code 521 of the above-described ECU update software, and the program code 521 may be directly executed in the non-volatile memory, or may be moved to the volatile memory and executed in the volatile memory.

The program code 521 of the ECU update software, which is stored in the memory unit 520 and executed by the control unit 530, is a program code that is written to perform an operation of updating the ECU 600 to be updated with the ECU update data transferred from the communication unit 510. As an example, the program code 521 may include a code for deleting, rewriting, and correcting firmware of the ECU 600 stored in the non-volatile memory.

The control unit 530 may be configured with a microcomputer (MICOM) or a microprocessor for overall controlling the operation of the update apparatus 500. The control unit 530 may control the MCAL and the ECAL through the drivers, and execute ECU update software code stored in the memory unit 520.

The control unit 530 may stop the operation of an OS for ECU update, and deactivate all interrupts other than an interrupt that is used for the communication unit 510 to receive the ECU update data and transfer the ECU update data to the control unit 530.

Moreover, the control unit 530 may stop the operation of the OS for ECU update, and deactivate all interrupts. The control unit 530 may operate the communication unit 510 in the polling scheme in order for the communication unit 510 to receive the ECU update data and transfer the ECU update data to the control unit 530.

As described above, the ECU update method and apparatus according to the present invention enables quick update of an ECU while performing an operation conforming to the AUTOSAR standard.

While the example embodiments of the present invention and their advantages have been described in detail, it should be understood that various changes, substitutions and alterations may be made herein without departing from the scope of the invention.

What is claimed is:

1. An electronic control unit (ECU) update method of an automotive open system architecture (AUTOSAR)-based system, comprising:
receiving, by an MCAL driver layer, ECU update data;
receiving, by an ECAL driver layer, the ECU update data from the MCAL driver layer; and
directly transferring, by the ECAL driver layer, the ECU update data to ECU update software.

2. The ECU update method of claim 1, further comprising:
stopping an operation of an operating system for ECU update; and
deactivating all interrupts other than an interrupt used in elements of a driver layer that receives the ECU update data and transfers the ECU update data to the ECU update software.

3. The ECU update method of claim 1, further comprising stopping an operation of an operating system for ECU update, and deactivating all interrupts.

4. The ECU update method of claim 3, wherein a driver layer, which receives the ECU update data and transfers the ECU update data to the ECU update software, operates in a polling scheme.

5. The ECU update method of claim 1, wherein,
in the MCAL driver layer, a FlexRay communication driver receives the ECU update data, and
in the ECAL driver layer, a FlexRay communication interface driver receives the ECU update driver and directly transfers the ECU update driver to the ECU update software.

6. The ECU update method of claim 1, wherein the directly transferring comprises directly transferring the ECU update data to the ECU update software without passing through at least one of a protocol data unit router layer, communication module layer, and run time environment layer of the AUTOSAR-based system.

7. An electronic control unit (ECU) update method of an automotive open to system architecture (AUTOSAR)-based system, comprising:
stopping an operation of an operating system for ECU update; and
deactivating all interrupts other than an interrupt used in elements of a driver layer that receives the ECU update data and transfers the ECU update data to the ECU update software.

8. The ECU update method of claim 7, further comprising stopping the operation of the operating system for ECU update, and deactivating all interrupts that comprise interrupts used in the elements of the driver layer.

9. The ECU update method of claim 8, wherein the driver layer, which receives the ECU update data and transfers the ECU update data to the ECU update software, operates in a polling scheme.

10. An update apparatus for updating an electronic control unit (ECU) in an automotive open system architecture (AUTOSAR)-based system, comprising:
a communication unit configured to receive ECU update data for updating the ECU;
a memory unit configured to store a program code for updating the ECU with the ECU update data received from the communication unit; and
a control unit configured to execute the program code to control the communication unit, and update the ECU with the ECU update data received from the communication unit.

11. The update apparatus of claim 10, wherein the communication unit receives the ECU update data through FlexRay communication.

12. The update apparatus of claim 11, wherein the control unit controls the communication unit to directly receive the ECU update data without passing through at least one of a protocol data unit router layer, communication module layer, and run time environment layer of the AUTOSAR-based system, and updates the ECU.

13. The update apparatus of claim 11, wherein the control unit stops an operation of an operating system for ECU update, and deactivates all interrupts other than an interrupt that is used for the communication unit to receive the ECU update data and transfer the ECU update data to the control unit.

14. The update apparatus of claim 11, wherein the control unit stops an operation of an operating system for ECU update, deactivates all interrupts, and controls the communication unit in a polling scheme such that the communication unit receives the ECU update data and transfers the ECU update data to the control unit.
